(19) United States
(12) Patent Application Publication
(10) Pub. No.: US 2012/0125211 A1
(43) Pub. Date: May 24, 2012

(54) METHOD FOR PRODUCING CATALYST LAYERS FOR FUEL CELLS

(75) Inventors: Reinhard Baumann, Krailling (DE); Andreas Willert, Chemnitz (DE); Frank Siegel, Chemnitz (DE); Albert Kohl, Laumersheim (DE)

(73) Assignee: SOLVICORE GMBH & CO. KG, Hanau-Wolfgang (DE)

(21) Appl. No.: 13/322,472

(22) PCT Filed: May 27, 2010
(86) PCT No.: PCT/EP2010/003226

§ 371 Date: Feb. 1, 2012

(30) Foreign Application Priority Data
May 29, 2009 (DE) 102009023160.9
Aug. 12, 2009 (EP) 09010356.5

(51) Int. Cl. B41M 1/10

(52) U.S. Cl. 101/170

(57) ABSTRACT

The present invention relates to a method for producing continuous catalyst layers on substrate materials by gravure printing with the aid of catalyst-containing inks, a printing plate being used which has at least one print image with an interrupted line screen whose longitudinal lines are arranged at an angle α of from 10 to 80° relative to the printing direction. Preferably, the print images have dip volumes in the range from range from 100 to 300 ml/m².

The catalyst layers produced are cohesive and continuous and have dry layer thicknesses in the range from 1 to 20 μm, preferably in the range from 2 to 15 μm.

### BACKGROUND OF THE INVENTION

The present invention relates to a method for producing fuel cell components, in particular a gravure printing method for producing catalyst layers, electrodes and membrane electrode units (“MEUs”) for polymer electrolyte membrane fuel cells (“PEM fuel cells”).

Fuel cells convert a fuel and an oxidizing agent in separate locations from one another at two electrodes into electricity, heat and water. As a rule, hydrogen or a hydrogen-rich gas serves as fuel and oxygen or air as the oxidizing agent. The process of energy conversion in the fuel cell is distinguished by a particularly high efficiency. For this reason, fuel cells in combination with electric motors are becoming increasingly important as an alternative to conventional internal combustion engines. Owing to its compact design, its power density and its high efficiency, the PEM fuel cell is suitable for use as an energy converter in motor vehicles.

The PEM fuel cell consists of a stack of membrane electrode units (“MEU”), between which bipolar plates for gas supply and current discharge are arranged. A membrane electrode unit consists of a solid polymer electrolyte membrane which is provided on both sides with catalyst-containing reaction layers. One of the reaction layers is in the form of an anode for the oxidation of hydrogen and the second reaction layer is in the form of a cathode for the reduction of oxygen. So-called gas diffusion layers (GDLs) comprising carbon fiber paper or carbon felt which promote good access of the reaction gases to the electrodes and good discharge of the cell current are applied to these reaction layers. Anode and cathode contain so-called electrocatalysts which catalytically support the respective reaction (oxidation of hydrogen at the anode or reduction of oxygen at the cathode). Catalytically active components used are as a rule the noble metals, preferably the metals of the platinum group of the Periodic Table of the Elements (PGMs). The majority of so-called supported catalysts used are those in which the catalytically active platinum group metals were applied in highly dispersed form to the surface of a conductive support material.

The polymer electrolyte membrane consists of proton-conducting polymer materials. These materials are also referred to below as ionomers for short. Preferably, a tetrafluoroethylene-fluorovinyl ether copolymer having acid functions, in particular sulfo groups, is used. Such materials are marketed, for example, under the trade name Nafion® (E.I. du Pont) or Flemion® (Asahi Glass Co.). However, other, in particular fluorine-free, ionomer materials, such as sulfonated polyether ketones or aryl ketones or polybenzimidazoles, can also be used. Moreover, ceramic membranes and other high-temperature materials can also be used.

The performance data of a fuel cell depend decisively on the quality of the catalyst layers applied to the polymer electrolyte membrane. These layers are generally highly porous and usually consist of an ionomer and a finely divided electrocatalyst dispersed therein. Together with the polymer electrolyte membrane, so-called three-phase interfaces form in these layers, the ionomer being in direct contact with the electrocatalyst and the gases led to the catalyst particles via the pore system (hydrogen at the anode, air at the cathode).

In view of a broad market penetration of the fuel cell technology in the mobile sector, a substantial reduction in the costs for the production of fuel cells, in particular of electrodes and membrane electrode units, is necessary.

Standard methods which permit coating speeds (or production speeds) in the range from 0.5 m/min to 2 m/min (=0.008 to 0.03 m/s) have been used to date for producing membrane electrode units. These are, for example, screen printing methods or knife coating methods. Substantially higher production speeds are required for use for mass production.

Coating methods having substantially higher speed are known from the area of print media. In this context, gravure printing technology is of particular interest. Gravure printing is used as a mass printing method in the printing of periodicals with long print runs and in the printing of packaging paper, decorative paper and securities. In the standard gravure printing method, screen patterns or dot patterns are produced but not cohesive areas.

The gravure printing method is of interest in particular because of the achievable high production speeds for mass production of fuel cell components. It permits a continuous process for substrate coating; moreover, the substrates can be coated in discrete patterns (printed images) or in solid, cohesive form in gravure printing.

The mode of operation of the gravure printing method is well known to the person skilled in the art in the area of printing technology. A detailed discussion in this context is to be found in Helmut Kipphan (editor), Handbuch der Printmedien—Technologien and Produktionsverfahren [Handbook of print media—technologies and production processes], Springer-Verlag, Berlin (2000). The general principle of gravure printing is shown in FIG. 1.

There, the meanings are as follows (cf. DIN 16528—Begriffe für den Tiefdruck [Definitions for gravure printing] in this context):
1 printing plate cylinder (printing plate)
2 print image
3 print motif (printed catalyst layer)
4 substrate material
5 impression cylinder
6 doctor with doctor blade
7 ink reservoir (inking system)
8 printing paste (ink, dispersion)
9 direction of rotation of printing cylinder
10 direction of rotation of impression cylinder
11 direction of movement of substrate material (printing direction)

In principle, in gravure printing, the ink present in an ink reservoir (7) is transferred to a roller-like printing plate cylinder (1) which moves in the direction of rotation (9). In the present application, this cylinder is referred to as “printing plate” or “sleeve”. Print images or screen areas (2) are introduced as cells on the printing plate (1). The printing paste/ink (8) flows into the cells of the print image (2) and fills them. With the aid of a doctor having a doctor blade (6), the excess printing paste/ink (8) is scraped off the printing plate. Thereafter, the printing paste/ink remaining in the cells of the print image (2) is transferred by means of an impression cylinder (5) to the surface of a substrate (4). The impression produced by the printing process or the layer (3) produced on the substrate (4) is referred to as print motif (3) in the present application.

Alternatively, the doctor (6) and the ink reservoir (7) can be combined and may be in the form of a closed inking system (for example in the form of a “chambered doctor blade system”). The ink supply then takes place via a chamber. Supernatant material is scraped off with a doctor blade which runs directly on the surface of the printing plate cylinder (1). The arrangements of the ink chamber and doctor blade system are arbitrarily variable.

As is evident from FIG. 2, a plurality of print images (2) can be provided on the printing plate cylinder (1). The number of print images is dependent on the available area of the printing plate cylinder and the size of the individual print images.

FIG. 3 shows an individual print image (2) in detail. The various bars (12) which form a screen or a screen structure are evident. This figure shows by way of example a line screen having additional transverse lines; however, all other screen structures according to the invention are also possible. The bars (12) represent partitions which separate the cells of a gravure printing plate from one another and, on scraping by the doctor blade (6), serve as a support for the latter.

Gravure printing permits a variable geometry of the desired print motif (3), i.e. elliptical or circular catalyst layers (print motifs) can also be produced in addition to rectangular ones. The amount of ink/paste transferred is determined by the dip volume of the printing plate (1) or the individual print images (2). High reproducibility of the layer thickness of the individual print motifs is obtained.

The use of gravure printing methods for producing electrodes and fuel cell components has already been proposed. Thus, DE 195 48 422 teaches a continuous production of material composites (i.e. MEU laminates) for fuel cells, screen printing, raised relief printing and gravure printing being used as coating methods. EP 1,037,295B2, too, discloses a method for applying electrode layers to a strip-like polymer electrolyte membrane for fuel cells. Screen printing is preferably used as the printing method. In both documents, the gravure printing method is mentioned but not described further.

U.S. Pat. No. 6,967,038B2 and U.S. Pat. No. 7,316,794 describe the production of catalyst-coated membranes by a flexographic raised relief printing method. This method comprises the use of preformed plates having raised reliefs which define the print motif. Catalyst paste is applied to the raised relief and is then transferred to the membrane. Disadvantages of this printing method are the inhomogeneous layer thickness and the poor edge definition of the print motifs.

U.S. Pat. No. 6,280,879 discloses a method for producing electrode/current collector laminates for electrochemical apparatuses, in particular Li polymer batteries. The patent teaches a method for producing thick layers of an electrode material on a current collector foil with the aid of the gravure printing method.

US 2004/0221755A1 describes a gravure printing method for producing multilayer ceramic capacitors. Electrode paste is applied in the form of rectangular print motifs to a ceramic foil. Each print image (“image area”) has bounding lines both parallel and perpendicular to the printing direction. As a result, individual cells are formed in the print images; nothing is known about the dip volume or the etch depth of these cells. The method is suitable in particular for highly viscous pastes containing metal powder.

WO 03/054991 A1 describes a gravure printing method for coating a fuel cell membrane with catalyst. The catalyst layers produced thereby are not homogeneous but have a multiplicity of three-dimensional structural units. The individual screen structures of the print image are present again in the catalyst layer. Owing to the lack of a continuous structure and the inhomogeneous layer thickness, the catalyst layers thus produced are not very suitable for PEM fuel cells.

EP 344089 A1 discloses a process for applying a fuel cell electrolyte matrix on an electrode by intaglio gravure printing. A conventional cell shape of a quadrangular pyramide is used. Such screens create a typical saw-chain structure at the edges of the printed image and the edge definition is not satisfactory.

WO 01/32422 A1 and DT 2624930 A1 describe a gravure printing equipment with conventional criss-cross line screens Such screens are well known and state of the art in the graphic industry. They are not suitable for printing of thick and continuous layers, as the dip volume and the etch depth is too low and the typical cell structure (truncated pyramid) do not provide an adequate ink transfer and leveling process.

It is therefore an object of the present invention to provide an improved gravure printing method by means of which catalyst layers having a cohesive, continuous structure can be produced. The method should be capable of being operated continuously, should permit a high printing speed or production speed and should be capable of being used both for direct coating of ionomer membranes and for coating of other substrate materials (transfer picture substrates, decals, PET films, coated papers, carbon fiber cloth, etc.). The catalyst layers produced by the method should show good electrical power in the fuel cell.

### SUMMARY OF THE INVENTION

The present invention relates to a method for producing continuous catalyst layers on substrate materials by gravure printing with the aid of catalyst-containing inks, a printing plate being used which has at least one print image with an interrupted line screen whose longitudinal lines are arranged at an angle α of from 10 to 80° relative to the printing direction. Preferably, the print images have dip volumes in the range from range from 100 to 300 ml/m².

The catalyst layers produced are cohesive and continuous and have dry layer thicknesses in the range from 1 to 20 μm, preferably in the range from 2 to 15 μm.

### BRIEF DESCRIPTION OF THE FIGURES

FIG. 1—shows the general principle of gravure printing.

FIG. 2,—shows a plurality of print images on the printing plate cylinder.

FIG. 3—shows an individual print image in detail.

FIGS. 4, 5, 6 and 7—schematically show the structure of the printing plates or print images according to the invention with linear screen structures.

FIGS. 8a, 8b, 8c and 8d—show line screens with flexible design structures.

FIG. 9—shows the modification of the length of the transversal lines (QL) against the printing direction. FIG. 9a illustrates a print image on the gravure printing plate and the printing direction and FIG. 9b shows a magnified section of FIG. 9a with labeled L and QL.

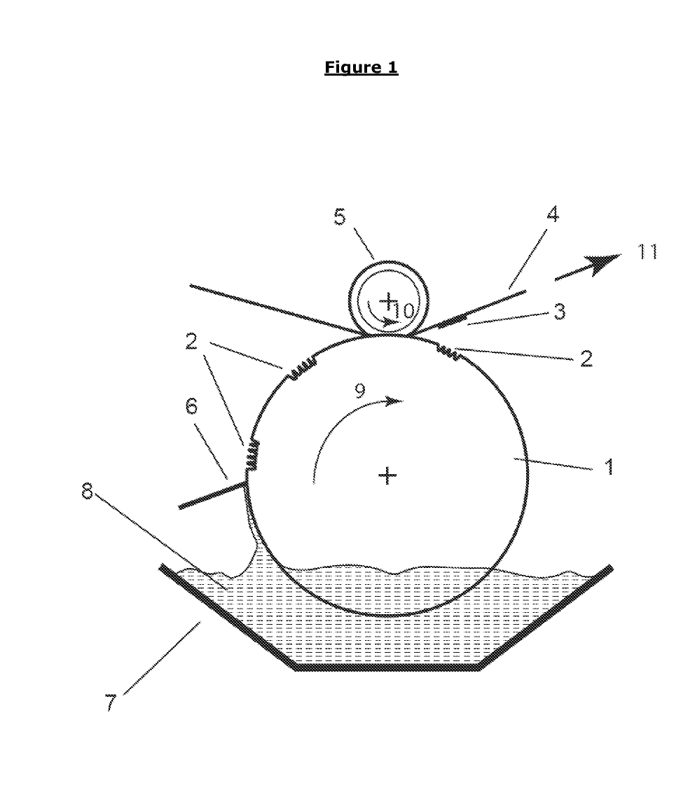

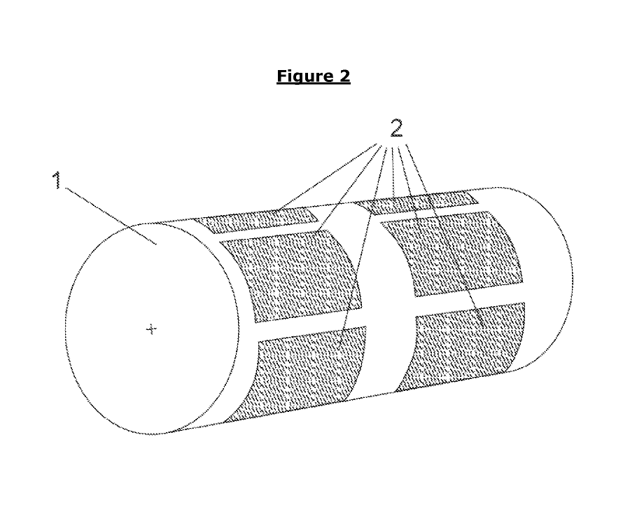

### DETAILED DESCRIPTION OF THE INVENTION

The present invention relates to a gravure printing method for producing catalyst layers on substrate materials with the aid of catalyst-containing inks, wherein a printing plate is used which contains at least one print image which has an interrupted line screen. The longitudinal lines of this interrupted line screen are arranged at an angle α of from 10° to 80°, preferably at an angle α of from 20° to 70°, relative to the printing direction.

In a possible embodiment of the method, the printing plate (or the print image) has a dip volume in the range from 100 to 300 ml/m², preferably in the range from 150 to 250 ml/m². In a further possible embodiment, the printing plate (or the print image) has an etch depth in the range from 100 to 250 μm, preferably in the range from 120 to 200 μm.

The catalyst layers produced by the method according to the invention should be cohesive or continuous. They should have a dry layer thickness in the range from 1 to 20 μm, preferably in the range from 2 to 15 μm and particularly preferably in the range from 5 to 10 μm.

It has been found that this object can be achieved by providing suitable printing plates or print images. The experiments showed that the dry layer thickness necessary for the catalyst layer can be achieved if a sufficient amount of catalyst ink is transferred to the substrate. As a result, it was found that the printing plate (or the print image) should have a certain dip volume. The printing plates (or print images) suitable for the method according to the invention have dip volumes in the range from 100 to 300 ml/m²; dip volumes in the range from 150 to 250 ml/m² are particularly suitable. This ensures that a sufficient volume of catalyst ink is transferred to the substrate. In the case of dip volumes which are too high, the ink is difficult to scrape off and this leads to print images which are not sharp (i.e. streaks outside the print images).

As was furthermore found in the experiments for the present invention, a printing plate (or print image) having an etch depth (H) in the range from 100 to 250 μm, preferably in the range from 120 to 200 μm, is necessary in order to achieve the desired dry layer thicknesses. These values are substantially above the printing plates used in gravure printing, whose etch depths are in the range from 10 to 50 μm.

Conventional gravure printing plates, such as criss-cross line screens or dot screens, have, as a rule, dip volumes of up to 40 ml/m². Such screens have a large number of regularly arranged cells which are filled with ink. In the printing process, the ink which has flowed into the cells is transferred to the substrate. In the course of the work, it was found that such conventional criss-cross line screens or dot screens are not very suitable for achieving the necessary dry layer thicknesses.

A further substantial aspect is the provision of a suitable screen structure or screen geometry for the printing plate. The screen structure suitable for the method according to the invention should occupy only a minimum volume in the transfer region on the printing plate (or in the print image) but should have a sufficient support function for the doctor (or the doctor blade) and permit good transfer of the ink to the substrate.

Surprisingly, the use of interrupted line screens has proven advantageous.

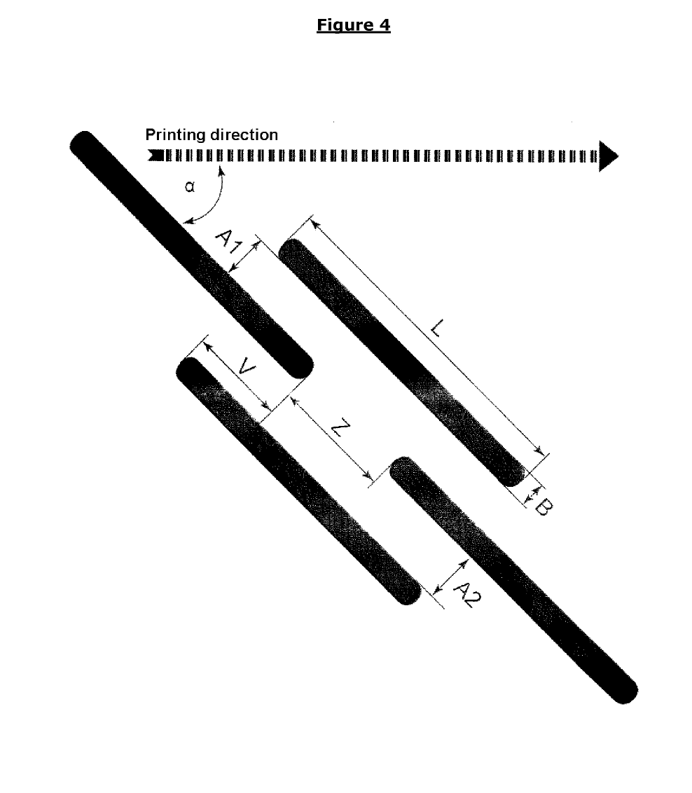

Such interrupted line screens have geometrical structural units which possess different length and width dimensions and different angles, optionally in combination. Within a print image, these structural units are repeated both one behind the other (i.e. in the x direction) and one above the other (i.e. in the y direction). The catalyst ink is present in the intermediate spaces between the individual lines or bars (12) of the print image (2) and is transferred to the substrate during the printing process. FIGS. 4, 5, 6 and 7 schematically show the structure of the printing plates or print images according to the invention with linear screen structures. Below, the meanings are as follows:
L=length of a longitudinal line
B=width of a longitudinal line
A1, A2=line spacings
Z=intermediate space between two lines of a row
V, V1, V2=row offset (positive and/or negative)
α=angle between printing direction and longitudinal line

In principle, two stated angles which define the respective direction of rotation (+α and −α) are possible for the angle α which defines the angle between the printing direction and the longitudinal lines. They result from the reflection of this angle at the printing direction as an axis. In the present patent application, the stated angle α comprises both directions of rotation or possibilities, especially since no observable differences in the arrangement of the line screen at the original or the reflected angle α relative to the printing direction have been found.

A further parameter for characterization of a gravure printing plate is the screen ruling F, defined in lines per unit of length (e.g. L/cm). The screen ruling is reciprocal to the sum of line spacing (A1, A2) and the width of the line next to the spacing (B) according to the following relationship:

F=1/A+B

In the case of different line spacings (A1 and A2), the screen ruling F is calculated as follows:

F=1/½(A1+B+A2+B)=2/(A1+B+A2+B)

For the printing plates or print images according to the present invention, the suitable values for the screen ruling F should be in the range of 5 L/cm to 20 L/cm, preferably in the range of 7 L/cm to 15 L/cm.

FIG. 4 shows an example of an interrupted line screen which has only parallel longitudinal lines but no transverse lines. In this example, the row offset V of the longitudinal lines is positive in each case, i.e. is in the form of an overlap.

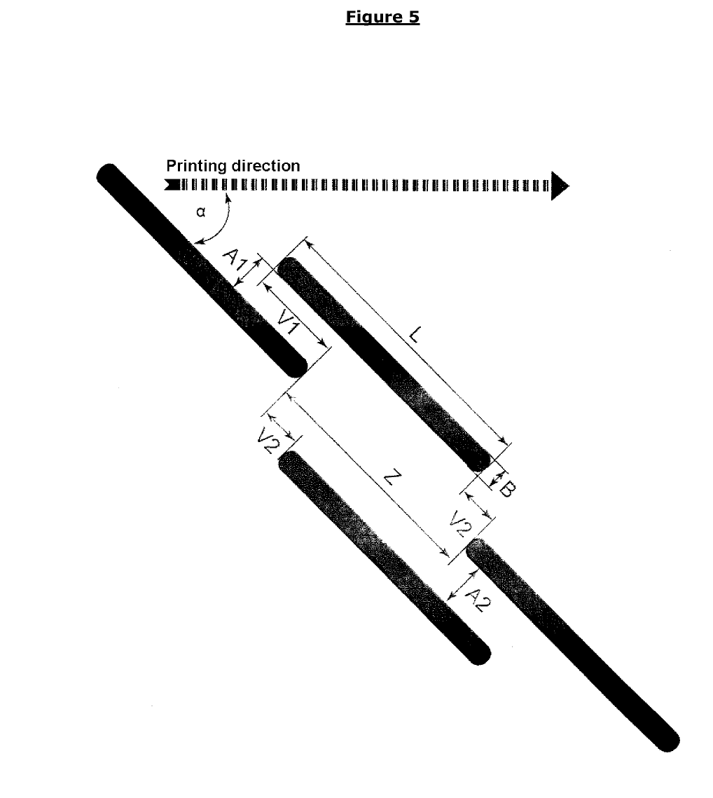

FIG. 5 shows an example of an interrupted line screen with longitudinal lines which have both a positive offset (V1) and a negative offset (V2), i.e. a gap.

FIG. 6 illustrates an example of an interrupted line screen with longitudinal lines and transverse lines. The longitudinal lines are oriented with the angle α in the printing direction while the transverse lines are arranged at a certain angle β to the longitudinal lines. Here, the meanings are additionally as follows:
QL=length of the transverse line
QB=width of the transverse line
QZ=intermediate space between transverse line and longitudinal line
β=angle between transverse line and longitudinal line.

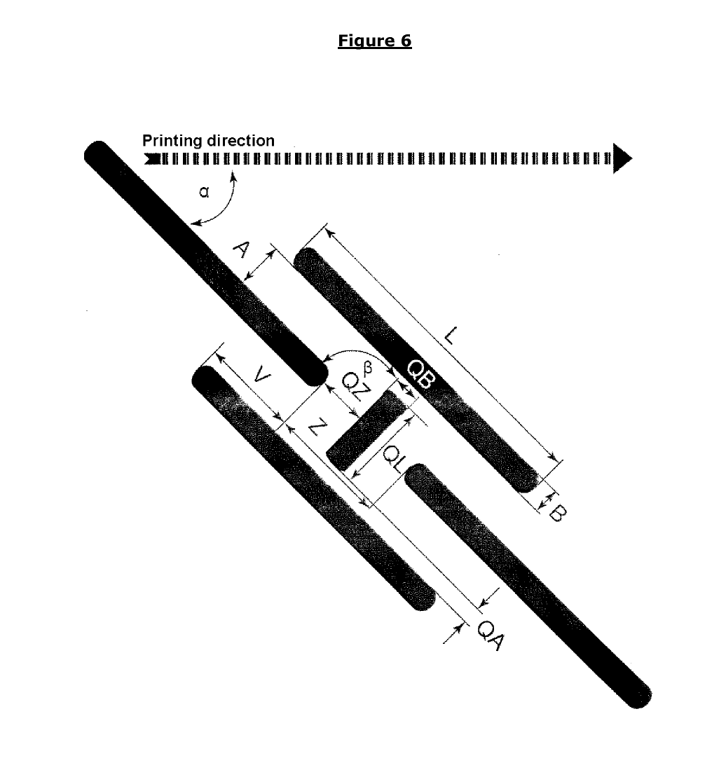

FIG. 7 likewise shows a line screen with longitudinal lines and transverse lines. The longitudinal lines are oriented at an angle α relative to the printing direction while the transverse lines make a certain angle β with the longitudinal lines and no intermediate space QZ is present between transverse line and longitudinal line (i.e. QZ=0).

In principle, all parameters, in particular lengths L, QL and widths B, QB and the row offset V, the intermediate space Z, the line spacing A and the angles α and β, are variable. Within a print image, these screen structures are repeated but they can also be varied within a print image in order, for example, to achieve better edge definition at the edge of the print image (for example in edge/center variations). In the extreme case, all these parameters can be arranged stochastically, comparable with stochastically frequency-modulated screens (“FM screens”) in the graphic arts industry. The following ranges have proven advantageous for the parameters:
L=from 1 to 20 mm, preferably from 1 to 15 mm
B, QB=from 0.05 to 0.5 mm, preferably from 1 to 0.5 mm
A1, A2=from 0.5 to 2 mm
Z=from 0.1 to 10 mm
V=(+/−) 0.1 to 10 mm
QL=from 0.1 to 4.5 mm
QZ=from 0 to 2.5 mm
α=from 10° to 80°, preferably from 20° to 70°
β=from 5° to 175°, preferably from 60° to 120°.

As a rule, thinner line structures are preferable to the broader structures in the method according to the invention since the broader structures prevent the formation of a self-leveling, homogeneous film. The line widths B (longitudinal lines) and QB (transverse lines) should be in the range from 0.1 to 0.5 mm. Furthermore, it has been found that, in the case of line lengths L of the longitudinal lines in the range from 0.1 to 20 mm, preferably in the range from 1 to 15 mm, good support of the doctor blade and hence a good printed copy are achieved. For the line lengths of the transverse lines (QL), values in the range from 0.1 mm to 4.5 mm have proven most useful. (Minimum value for QL: width of a longitudinal line (B); maximum value for QL: sum of the values B+A1+A2.) Excessively long line structures have proven disadvantageous. They result in transport of the ink in the printing direction owing to the adhesion of the ink to the doctor blade (ink “dislocation”).

The suitable dimensions for the parameter Z (=intermediate space between two lines of a row) are in the range from 0.1 to 10 mm; suitable values for V (=row offset between the line rows) are in the range from 0.1 to 10 mm. The row offset V may be in the form of either an overlap (i.e. positive) or a gap (i.e. negative).

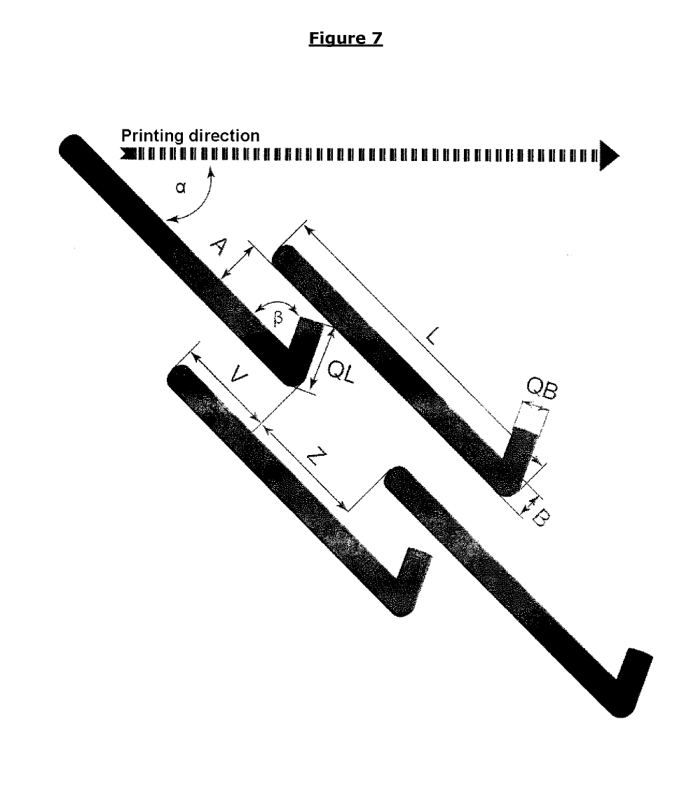

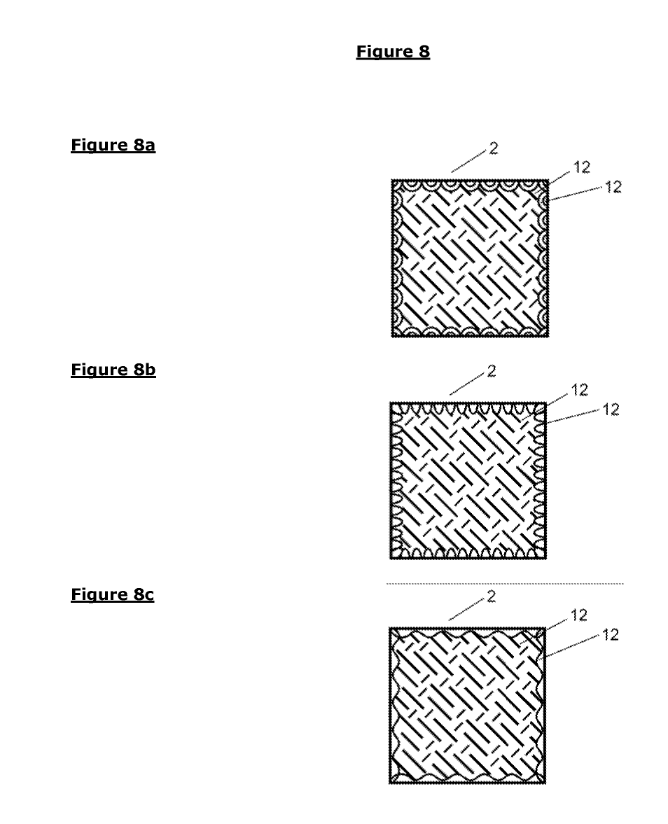

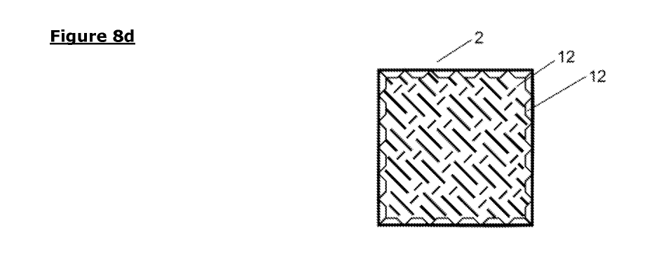

The interrupted line screens are arranged in the longitudinal direction (i.e. based on the length L) at an angle α of from 10° to 80°, preferably at an angle α of from 20° to 70°, relative to the printing direction. The optional transverse lines QL are arranged at an angle β relative to the longitudinal lines L, the angle β being in the range from 5° to 175°, preferably in the range from 60° to 120°. Longitudinal lines and transverse lines can, however, also meet one another at an angle β, a hook-shaped screen being formed (cf. FIG. 7). In a further embodiment of the present invention, line screens with a flexible design structure can be used. It was found that by modifications of the line screen with different structures at the rim of the print image, a better edge definition in the printed motif (the layer on the substrate) can be achieved. To improve the ink transfer, the use of screens with semi-circles (FIG. 8a), rounded triangles (FIG. 8b), sinus waves (FIG. 8c) or polygons (FIG. 8d) is also suitable.

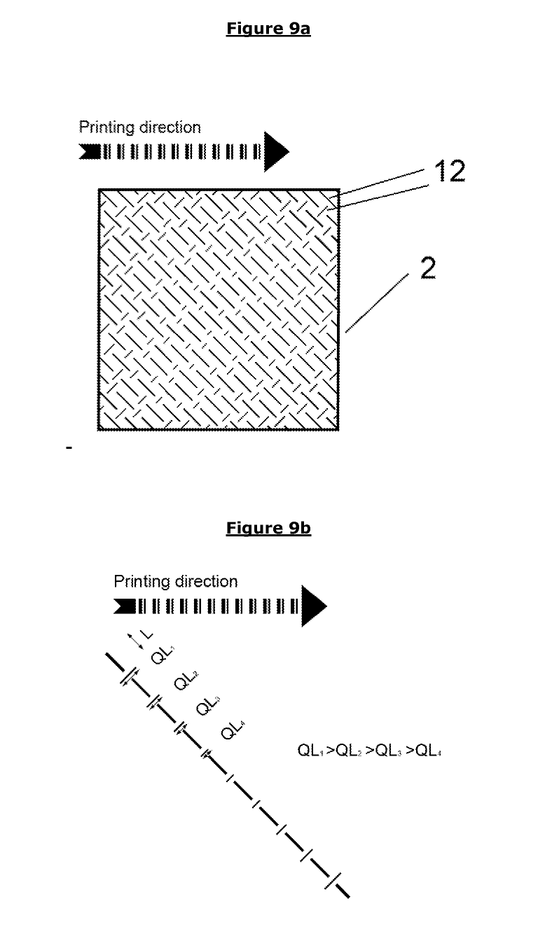

Mainly at the beginning and at the end of the print image, a dislocation of the printing ink is observed. It was found that this effect can be prevented by the use of screens with longer transversal lines in this region. FIG. 9 shows the modification of the length of the transversal lines (QL) against the printing direction. FIG. 9a illustrates a print image on the gravure printing plate and the printing direction. It should be noted that the length of the transversal lines QL is decreasing towards the middle of the print image. Furthermore, the length of the transversal lines QL is decreasing and increasing in printing direction. For better illustration, FIG. 9b shows a magnified section of FIG. 9a with labeled L and QL.

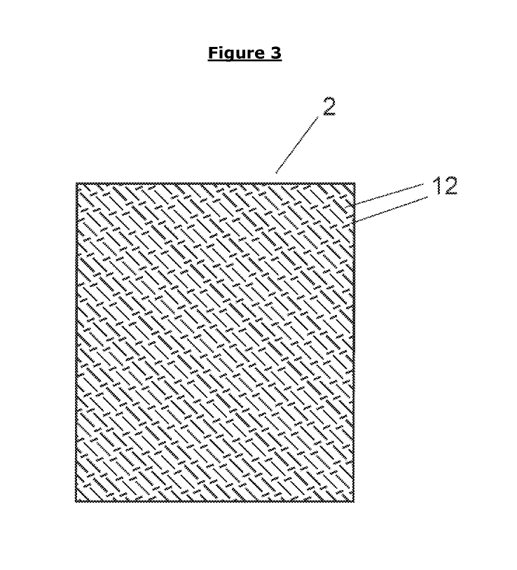

The line screens with transversal lines mentioned above (e.g. FIG. 3 and FIGS. 5 to 9) provide smaller transversal lines compared to the longitudinal lines (QL<L). For this reason, the line screens have a preferred orientation in the printing direction.

In summary, it was found that, by means of the screen structures according to the invention, the transport movement (“dislocation”) of the ink within the printing plate or the print image is reduced and a uniform print motif is achieved. Further advantages are the greater edge definition of the print motif, the stabilization of the doctor and the lower level of wear (e.g. abrasion, damage to bars, etc.) of the printing plate cylinder.

In a preferred embodiment of the present invention, a chambered doctor blade system is applied. This system improves the ink distribution on the gravure cylinder and helps to prevent the evaporation of ink solvents in the ink reservoir. In general, a chambered doctor blade system comprises a chamber where the ink is filled in, an operative doctor blade and a closing doctor blade. Normally, the closing doctor blade is angled against the direction of rotation (i.e. negatively angled). It was found by the inventors, that, in order to prevent catching of the doctor blade, it is advantageous to set the closing doctor blade in the direction of rotation, i.e. identical to the operative doctor blade. Furthermore, the chamber should envelop a major part of the gravure printing plate cylinder in order to maximize the real inking time and to decrease the evaporation of ink solvents.

The catalyst layers produced with the printing plates or print images according to the invention are cohesive and continuous. They generally have a dry layer thickness in the range from 1 to 20 μm, preferably in the range from 2 to 15 μm and particularly preferably in the range from 5 to 10 μm. In the standard gravure printing method, screen patterns or dot patterns are usually produced but not cohesive areas. With the method according to the invention, on the other hand, catalyst layers having a cohesive, continuous structure can be produced. In the resulting print motif, only a negligible surface structure is detectable; the catalyst layers have little surface roughness.

The production of printing plates, printing plate cylinders, print images and screen structures is known to the person skilled in the art in the area of gravure printing technology. The print images required for the method according to the invention and having interrupted line screens are exposed on a printing plate cylinder (or sleeve cylinder) and then etched to the desired depth in the range from 50 to 250 μm, preferably in the range from 100 to 200 μm. Diameter and circumference of the printing plate cylinder or sleeve cylinder are dependent on the type of gravure printing press and can be varied within wide limits. The finished printing plate sleeve is drawn onto the sleeve cylinder for the printing process so that the dimensional stability necessary for the printing process is present.

In principle, any catalyst pastes or catalyst inks having a very wide range of compositions can be used for the method according to the invention. The catalyst inks suitable for the method contain in principle at least one catalyst material, at least one ionomer material and at least one solvent. All catalysts known in the area of fuel cells, in particular electrocatalysts, can be used as catalyst materials. In the case of supported electrocatalysts, a finely divided, electroconductive material is generally used as a support, whereby carbon blacks or graphites, but also conductive oxides, can preferably be used. The noble metals, preferably the elements of the platinum group of the Periodic Table of the Elements (Pt, Pd, Ru, Rh, Os, Ir) or alloys thereof, serve as a catalytically active component. The catalytically active metals may contain further alloy additives, such as, for example, cobalt (Co), chromium (Cr), tungsten (W) or molybdenum (Mo). As a rule, supported catalysts (e.g. 40% by weight of Pt/C) in which the catalytically active platinum group metals are applied in finely divided form to the surface of a conductive carbon black support are used. For the production of the electrode layers, however, support-free catalysts, such as, for example, platinum blacks or platinum powder having a large surface area, can also be used.

As a rule, proton-conducting polymer materials are used as ionomer material. A tetrafluoroethylene-fluorovinyl ether copolymer having acid functions, in particular having sulfo groups, is preferably used. Such materials are marketed, for example, under the trade name Nafion® (Du Pont) or Flemion® (Asahi Glass Co.). Many fluorine-containing ionomer materials are obtainable in the form of solutions or dispersions in different concentrations. In addition, ionomers having different equivalent weights (EW) are also available from various manufacturers.

For achieving a homogeneous layer having a uniform layer structure, good leveling or “spreading” of the individual ink deposit after application should be achieved. For the gravure printing method according to the invention, catalyst inks having adapted rheological properties (i.e. adapted viscosity) should therefore be used. The viscosity of the inks should advantageously not be too high so that, after application, a certain leveling on the substrate material is possible. The solids content of the catalyst ink should, however, also not be too low, so that the required dry layer thickness can be achieved.

Suitable catalyst inks or catalyst dispersions have a viscosity in the range from 50 to 1000 mPa·s, preferably in the range from 50 to 900 mPa·s and particularly preferably in the range from 150 to 400 mPa·s (at a shear rate of D=1000 s⁻¹, measured using a plate/cone viscometer). For the measurements for the present application, a plate/cone viscometer of the type MCR 300 from the company Physica (from Anton Paar GmbH, D-73760 Ostfildern) was used. However, devices of other manufacturers can also be used.

Suitable inks have a solids content (i.e. the sum of catalyst fraction and ionomer fraction) from 3 to 20% by weight, preferably from 5 to 20% by weight and particularly preferably a solids content from 7 to 16% by weight (measured in each case by the loss on drying, based on the total weight of ink taken). The loss on drying is determined on drying in a circulation drying oven at 120° C. for 60 minutes.

In principle, all organic solvents which are suitable for catalyst inks which are processed in coating methods, in particular printing methods, can be used as solvents. Water-containing catalyst inks are preferred from environmental points of view and with regard to work safety.

The present invention provides a gravure printing method for producing continuous, cohesive catalyst layers on a very wide range of substrate materials. The printing parameters which are advantageous for the method according to the invention, such as production speed, throw-on angle of the doctor blade, doctor blade contact pressure, impression cylinder pressure and impression cylinder hardness, are stated below.

The impression cylinder is pressed onto the printing plate cylinder with a pressure from 2 to 10 bar, preferably from 3 to 6 bar. The impression cylinder hardness is usually in the range from 50 to 100 Shore. As a rule, a contact pressure of the doctor of from 1 to 2 bar is employed. The web speed (or printing speed) is in the range from 0.02 to 3 m/s, preferably in the range from 0.1 to 1 m/s. As a rule, stainless steel or plastic is used as material for the doctor or doctor blade. The throw-on angle of the doctor is in the range from 50 to 85°, preferably in the range from 60 to 83° (measured to the cylinder tangent of the printing plate cylinder). Such doctor angles give good results with the use of the catalyst inks according to the invention.

In a particular embodiment, a gravure printing unit having a closed inking system (i.e. chambered doctor blade system) is used. As a result, evaporation effects due to volatile solvents in the printing ink are avoided.

In principle, all strip-like ionomer membranes (in supported or unsupported form, as composites, as laminated membranes or as multilayer membranes), treated or untreated plastics films (polyesters, PET, polyamides, polyimides, etc.), transfer picture substrates (“decal substrates”), coated and/or treated papers, laminated films, but also carbon fiber substrates (such as, for example, carbon fiber webs, woven carbon fiber fabrics or carbon fiber papers) can be used as substrate materials. Suitable substrate materials should have little surface roughness and low thermal expansion, in order to ensure stable web running during printing and during the subsequent drying.

The drying after the printing can be effected by a batchwise and/or continuous method. For batchwise operation, drying ovens or drying cabinets are suitable; for continuous operation, it is possible to use, for example, continuous belt dryers, which can be integrated in the gravure printing unit. Preferably, the drying of the substrate web is effected by the in-line method using hot-air dryers or IR dryers. The temperature of the drying is typically from 20 to 150° C., and the drying parameters should be adapted to the respective method and are in general from a few seconds to several minutes.

As already mentioned, the catalyst layers produced by the method according to the invention are cohesive and continuous. They are as a rule opaque, i.e. they have a low light transmittance when viewed in the transmitted light mode. In the present application, the surface roughness is used as a measure of the homogeneity and the continuous structure of the applied catalyst layer. The surface texture is measured by the profile method according to DIN EN ISO 4287 (October 1998) via the determination of the Rₐ value (=the arithmetic mean of the profile ordinates). For this purpose, the surface roughness is determined over a measuring distance of 1 mm length on a smooth substrate (PET film) and in each case the Rₐ value is determined. The mean value of three measurements is calculated and is stated as the value. The device used is a tactile profilometer (tactile roughness measuring device). The measurements for the present application were carried out using the Veeco Dektak 8 (Veeco Instruments Inc; Plainview, N.Y. 11803, USA). However, other devices can also be used for this purpose.

The catalyst layers produced furthermore have a dry layer thickness in the range from 1 to 20 μm, preferably in the range from 2 to 15 μm and particularly preferably in the range from 5 to 10 μm. The determination of the dry layer thickness is also effected using a profilometer (Veeco).

The layers produced according to the invention are cohesive and continuous and have low surface roughness. Typically, the Rₐ value is in the range of <10% of the respective dry layer thickness. This means that catalyst layers having a thickness of 1 μm have an Rₐ value of <0.1 μm, while catalyst layers having a thickness of not more than 20 μm have an Rₐ value in the range <2 μm. The layers produced in the examples and having a thickness of about 8 μm accordingly have Rₐ values in the range <0.8 μm.

An advantage of the gravure printing method according to the invention lies in the achievement of high printing speeds (or web speeds), values of from 0.02 to 3 m/s, preferably in the range from 0.1 to 1 m/s, being achieved. Furthermore, the method can be operated continuously and the drying process can be integrated into the method (for example as a roll-to-roll process). Production speeds of from 0.02 to 3 m/s, preferably from 0.1 to 1 m/s, are achievable thereby. Moreover, continuous, automated MEU production in which further steps, such as, for example, isolation, cutting to size and lamination of the substrates, are included is possible.

With the catalyst layers produced by the method according to the invention, membrane electrode units were produced and were tested in PEM fuel cells. The electrical performance values of the MEUs produced according to the invention are comparable with the values which are achieved with MEUs which are produced in the conventional production process.

The method according to the invention is to be described in more detail in the following examples.

### EXAMPLES

### General Preliminary Remarks

The experiments are effected on a laboratory gravure printing unit developed by ourselves, at room temperature and relative humidity of 30-50% relative humidity. In the case of the experiments carried out here, the sleeve cylinder produced has a diameter of 220 mm and hence a circumference of 691.2 mm. The finished printing plate sleeve is drawn onto the sleeve cylinder with the aid of compressed air for the printing process. Print images (screen segments) having a geometrical size of 3×3 cm² and 3×5 cm² are used. The printing plates used were produced by Sächsische Walzengravur GmbH (SWG, D-09669 Frankenberg). The web width is 35 mm. The gravure printing is effected using an chambered doctor blade system, a throw-on angle of 60° to the cylinder tangent being used. The printing ink supply is performed via a printing tank having a container pressure of 1.0 bar.

### Example 1

### Production of Pt Catalyst Layers on a Decal Substrate

A Pt-containing catalyst ink “DS4/type 31” (containing a carbon black-supported Pt catalyst of the type 20% by weight Pt/C and ionomer and organic solvents) is processed on the laboratory gravure printing press at a temperature of 21° C. and relative humidity of 30%.

The viscosity of the ink is 350 mPa·s@ D=1.000 s⁻¹ (measured with Physica MCR 300). The solids content is 13% by weight.
Experimental parameters:
Substrate: decal film (polyester film, 80 μm thickness)
Printing speed: 0.125 m/s
Etch depth of printing plate: 180 μm
Screen structure: long line screen (interrupted)
   angle α=45°
   A1=0.5 mm
   A2=2×A1=1.0 mm
   B=0.3 mm
   L=12 mm
   Z=8 mm
   V1=5 mm
   V2=−0.5 mm (negative offset)
   F=10 L/cm (screen ruling)
Drying: 40 s at 100° C. (continuous drier)
Active area: about 10 cm² (after printing)
Dry layer thickness: 8 μm
Roughness: cohesive, opaque layer
   Rₐ=0.66 μm (PET substrate, mean value) (Veeco Dektak 8)
Active area: about 10 cm² (after printing)

### Electrochemical Test:

Two print motifs printed on the decal film (active area 10 cm²) are relaminated with the front and back of an ionomer membrane (type Nafion© 112, thickness 50 μm, H⁺ form). The catalyst-coated membrane is processed with suitable GDLs (“gas diffusion layers”) to give a 5-layer membrane electrode unit (MEU) and measured in a PEM fuel cell (single cell) in hydrogen/air operation (pressure 1 bar abs). The electrochemical performance of this MEU is comparable with the performance of an MEU produced in the standard printing method.

### Example 2

### Production of Pt Catalyst Layers in the Gravure Printing Method

The catalyst ink “DS4/type 31” is processed as described in example 1 on the laboratory gravure printing press. The printing plate used is a short line screen. The geometrical dimensions are stated below.
Screen structure: short line screen (interrupted)
   angle α=25°
   A1=A2=0.4 mm
   B=0.3 mm
   L=1.5 mm
   Z=0.5 mm
   V=0.4 mm
   F=14 L/cm

A 125 μm thick polyester film (PET) is used as the decal substrate. After drying in the continuous dryer, cohesive, opaque catalyst layers which have a dry layer thickness of 7-8 μm are obtained. The roughness Rₐ is about 0.6 μm.

### Comparative Example 1

### VB1

### Production of Layers on a Decal Substrate in the Gravure Printing Method

### Conventional Criss-Cross Line Screen

A model ink of the type HWD 06 is processed on the laboratory gravure printing press at a room temperature of 21° C. and a relative humidity of 30%. A decal film (polyester film, 80 μm thickness) is used as the substrate. The viscosity of the ink is 250 mPa·s @ 1.000 s⁻¹ (measured with Physica MCR 300). The solids content is 14% by weight.

### Experimental Parameters:

Printing speed: 0.4 m/s
Printing plate: cell depth 53 μm
Dip volume: 17 ml/m²
Screen structure: printing plate DF 1
   four-track criss-cross line screen
   screen ruling F=54 L/cm
Layer thickness: about 0.7 μm (not homogeneous)

After drying in the continuous dryer, cohesive, opaque catalyst layers are not obtained. The layer is transparent to light, the individual screen dots being recognizable as a pattern.

### Comparative Example 2

### VB2

### Production of Layers on a Decal Substrate in the Gravure Printing Method

### Closed and Interrupted Line Screen at Low Angle (α=3°)

In these experiments, a laboratory gravure printing press was used at a web width of 140 mm. A model ink (type R-07-G, solids content 13% by weight, viscosity 200 mPas @ D=1.000 s⁻¹) was employed for printing on a PET substrate. Printing conditions were 19° C. and 40% relative humidity.

### Experimental Parameters:

Printing speed: 0.2 m/s
Etch depth of printing plate: 160 μm
Printing plate: Closed line screen (a)
   Interrupted line screen (b)
Screen structure (a) and (b): angle α=3°
   A1=A2=1.1 mm
   B=0.3 mm
   L=6 mm
   Z=1.5 mm
   V=0.5 mm

After drying, the printed electrodes were examined visually. The closed line screen (a) with angle α=3° shows many print defects, particularly in the middle region and on the edges of the printed motif due to dislocation of the ink by the doctor blade. The printed electrodes made with an interrupted line screen (b) with angle α=3° revealed some printing defects and a low edge definition.

1. A gravure printing method for producing catalyst layers on substrate materials which comprises using a catalyst-containing ink and a printing plate which has at least one print image with an interrupted line screen whose longitudinal lines are arranged at an angle α of from 10° to 80° relative to the printing direction.

2. The method as claimed in claim 1, wherein the print image has a dip volume in the range from 100 to 300 ml/m².

3. The method as claimed in claim 1, wherein the print image has etch depths in the range from 100 to 250 μm.

4. The method as claimed in claim 1, wherein the catalyst layers have a dry layer thickness in the range from 1 to 20 μm.

5. The method as claimed in claim 1, wherein the longitudinal lines of the line screen have line lengths L in the range from 0.1 to 20 mm and line widths B in the range from 0.05 to 0.5 mm.

6. The method as claimed in claim 1, wherein the interrupted line screen has at least one intermediate space Z between two lines of a row, whose dimensions are in the range from 0.1 to 20 mm.

7. The method as claimed in claim 1, wherein the print image has a line screen with additional transverse lines, the transverse lines having line lengths (QL) in the range from 0.1 mm to 4.5 mm and which are arranged at an angle β in the range from 5° to 175° relative to the longitudinal lines.

8. The method as claimed in claim 1, wherein the print image has a screen ruling from 5 L/cm to 20 L/cm.

9. The method as claimed in claim 1, wherein the catalyst layers have a low surface roughness and the Rₐ value being <10% of the respective dry layer thickness.

10. The method as claimed in claim 1, wherein the substrate materials are selected from the group consisting of ionomer membranes (in supported or unsupported form), composite membranes, laminated membranes, multilayer membranes, treated or untreated plastics films, transfer picture substrates, decal substrates, coated or treated papers, laminated films and carbon fiber substrates.

11. The method as claimed in claim 1, wherein the catalyst-containing ink comprises at least one electrocatalyst, at least one ionomer and at least one solvent.

12. The method as claimed in claim 1, wherein the catalyst-containing ink has a solids content in the range from 3 to 20% by weight (measured as loss on drying at 120° C./60 minutes).

13. The method as claimed in claim 1, wherein the catalyst-containing ink has a viscosity in the range from 50 to 1,000 mPa·s (measured using a plate/cone system).

14. The method as claimed in claim 1 further comprising supplying the ink via a chambered doctor blade system

15. The method as claimed in claim 1, wherein the method is effected continuously in a roll-to-roll method.

16. The method as claimed in claim 1, wherein the method is conducted at a printing speed in the range from 0.02 to 3 m/s.

17. A method for producing electrodes and membrane electrode units for fuel cells which comprises using the gravure printing method of claim 1.

18. A gravure printing plate for producing catalyst layers on substrate materials, which comprises at least one print image with an interrupted line screen whose longitudinal lines are arranged at an angle α of from 10° to 80°relative to the printing direction.

19. The method as claimed in claim 1, wherein the angle α of from 20° to 70° relative to the printing direction.

20. The method as claimed in claim 1, wherein the print image has a dip volume in the range from 150 to 250 ml/m².

21. The method as claimed in claim 1, wherein the print image has etch depths in the range from 120 to 200 μm.

22. The method as claimed in claim 1, wherein the catalyst layers have a dry layer thickness in the range from 2 to 15 μm.

23. The method as claimed in claim 1, wherein the catalyst-containing ink has a viscosity in the range from 150 to 400 mPa·s (measured using a plate/cone system).
